(19) United States
(12) Patent Application Publication
(10) Pub. No.: US 2018/0330898 A1
(43) Pub. Date: Nov. 15, 2018

(54) KEYBOARD DEVICE

(71) Applicant: Primax Electronics Ltd., Taipei (TW)

(72) Inventors: BO-AN CHEN, Taipei (TW); CHUNG-YUAN CHEN, Taipei (TW); CHIN-SUNG PAN, Taipei (TW)

(21) Appl. No.: 15/785,964

(22) Filed: Oct. 17, 2017

(30) Foreign Application Priority Data
May 12, 2017 (TW) 106115803

(51) Int. Cl. H01H 13/7073; H01H 13/79

(52) U.S. Cl. CPC H01H 13/7073; H01H 2215/044; H01H 2215/03; H01H 13/79

(57) ABSTRACT

A keyboard device includes a wiring board with plural key switches, plural key structures corresponding to the plural key switches, and an anti-ghosting unit. Each of the plural key structures includes a keycap, a scissors-type connecting element and a light-emitting element. The light-emitting element is located under the keycap. At least a part of the scissors-type connecting element is arranged between the keycap and the wiring board. The keycap is movable upwardly or downwardly relative to the wiring board. The anti-ghosting unit is disposed on the wiring board or electrically connected with the wiring board. The anti-ghosting unit is used for avoiding key conflict between at least two of the plural key structures.

### FIELD OF THE INVENTION

The present invention relates to an input device, and more particularly to a keyboard device.

### BACKGROUND OF THE INVENTION

Generally, the widely-used peripheral input device of a computer system includes for example a mouse device, a keyboard device, a trackball device, or the like. Via the keyboard device, characters or symbols can be inputted into the computer system directly. As a consequence, most users and most manufacturers of the input devices pay much attention to the keyboard devices.

The structure and function of a conventional keyboard device will be described with reference to FIGS. 1 and 2. FIG. 1 is a schematic side view illustrating a conventional keyboard device. FIG. 2 is a schematic exploded view illustrating a portion of a membrane wiring board of the conventional keyboard device of FIG. 1. The conventional keyboard device 1 comprises a reflecting plate 15, a light guide plate 16, a base plate 13, a membrane wiring board 14, plural key structures 12 and plural light-emitting elements 11. Each of the plural key structures 12 comprises a keycap 121, a scissors-type connecting element 122 and an elastic element 123. The scissors-type connecting element 122 is connected between the keycap 121 and the base plate 13. Moreover, the scissors-type connecting element 122 comprises a first frame 1221 and a second frame 1222. The second frame 1222 is pivotally coupled to the first frame 1221. Consequently, the first frame 1221 and the second frame 1222 can be swung relative to each other. The elastic element 123 is arranged between the keycap 121 and the membrane wiring board 14. Moreover, the elastic element 123 comprises a contacting part 1231.

The membrane wiring board 14 comprises an upper film layer 142, a lower film layer 141 and an intermediate film layer 143. The intermediate film layer 143 is arranged between the upper film layer 142 and the lower film layer 141. A first circuit pattern 1421 is formed on a bottom surface of the upper film layer 142. The first circuit pattern 1421 comprises plural upper contacts 14211 corresponding to the plural key structures 12. A second circuit pattern 1411 is formed on a top surface of the lower film layer 141. The second circuit pattern 1411 comprises plural lower contacts 14111 corresponding to the plural upper contacts 14211. In addition, the intermediate film layer 143 comprises plural perforations 1431 corresponding to the plural upper contacts 14211 and the plural lower contacts 14111. Each of the upper contacts 14211 and the corresponding lower contact 14111 are collectively defined as a membrane switch 144.

While the keycap 121 of any key structure 12 is depressed and moved downwardly relative to the base plate 13, the first frame 1221 and the second frame 1222 of the scissors-type connecting element 122 are switched from an open-scissors state to a stacked state. Moreover, as the keycap 121 is moved downwardly to compress the elastic element 123, the corresponding upper contact 14211 is contacted with and triggered by the contacting part 1231 of the elastic element 123. Consequently, the corresponding upper contact 14211 is penetrated through the corresponding perforation 1431 and contacted with the corresponding lower contact 14111. Under this circumstance, the corresponding membrane switch 144 is electrically conducted. When the keycap 121 of the key structure 12 is no longer depressed, the keycap 121 is moved upwardly relative to the base plate 13 in response to an elastic force of the elastic element 123. Meanwhile, the first frame 1221 and the second frame 1222 are switched from the stacked state to the open-scissors state again, and the keycap 121 is returned to its original position.

The base plate 13 is located under the membrane wiring board 14. Moreover, the base plate 13 comprises plural base plate openings 131 corresponding to the plural key structures 12. The light-emitting elements 11 are located at bilateral sides of the light guide plate 16 for providing light beams to the light guide plate 16. The light guide plate 16 is disposed on the reflecting plate 15. Moreover, plural light-guiding dots 161 are formed on a bottom surface of the light guide plate 16 for collecting and scattering the light beams. The plural light-guiding dots 161 are aligned with corresponding key structures 12.

After the light beams are introduced into the light guide plate 16, the light beams are diffused into the whole light guide plate 16. Due to the properties of the light-guiding dots 161, the light beams will be scattered upwardly and downwardly. The portions of the light beams that are scattered upwardly will be sequentially transmitted through the base plate openings 131 of the base plate 13 and the membrane wiring board 14 and then projected to the plural key structures 12. The portions of the light beams that are scattered downwardly will be reflected by the reflecting plate 15, and the reflected light beams are directed upwardly. Consequently, the light beams provided by the light-emitting elements 11 can be well utilized. In other words, the keycaps 121 of the key structures 12 are illuminated.

Although the keyboard device 1 provides the above backlight functions, there are still some drawbacks. For example, the backlight functions provided to the keycaps 121 of all key structures 12 are enabled or disabled simultaneously. That is, it is difficult to enable the backlight functions of the keycaps 121 of designated key structures 12 and disable the backlight functions of the keycaps 121 of the other key structures 12.

For achieving the amusement purpose (e.g., in electronic sports product) or the anti-ghosting purpose, a keyboard device with mechanical switches has been introduced into the market. Please refer to FIGS. 3 and 4. FIG. 3 is a schematic cross-sectional view illustrating a conventional keyboard device with a mechanical key structure. FIG. 4 is a schematic cross-sectional view illustrating the mechanical switch of the conventional keyboard device of FIG. 3 when a keycap of the mechanical key structure is depressed. For succinctness, only one mechanical key structure and associated components are shown in the drawings.

The keyboard device 2 comprises plural mechanical key structures 22 and a circuit board 21. Each mechanical key structure 22 comprises a keycap 221, a mechanical switch 224 and a light-emitting element 23. The mechanical switch 224 is arranged between the keycap 221 and the circuit board 21. The light-emitting element 23 is disposed on the mechanical switch 224. The light-emitting element 23 of each mechanical key structure 22 emits light beams to the corresponding keycap 221 to provide an illuminating effect. The mechanical switch 224 comprises a casing 2241, a push element 2242, a linkage element 2243, a first spring strip 2244, a second spring strip 2245 and an elastic element 2246. The linkage element 2243, the elastic element 2246, at least a part of the push element 2242, at least a part of the first spring strip 2244 and at least a part of the second spring strip 2245 are accommodated within the casing 2241.

The casing 2241 comprises a pedestal 22411 and an upper cover 22412. The pedestal 22411 is covered by the upper cover 22412. Moreover, the upper cover 22412 has an upper cover opening 22413. A first end of the push element 2242 is penetrated through the upper cover opening 22413 and contacted with the keycap 221. A second end of the push element 2242 is disposed within the casing 2241 and connected with the linkage element 2243. The linkage element 2243 is located at a middle region of the pedestal 22411. Moreover, the linkage element 2243 is movable upwardly or downwardly relative to the pedestal 22411. The linkage element 2243 has a protrusion structure 22431. The protrusion structure 22431 is extended from a sidewall of the linkage element 2243 toward the first spring strip 2244. The elastic element 2246 is located under the linkage element 2243. A first end of the elastic element 2246 is connected with the linkage element 2243. A second end of the elastic element 2246 is fixed on the pedestal 22411. Moreover, the elastic element 2246 provides an elastic force to the linkage element 2243.

The first spring strip 2244 is located near a sidewall of the pedestal 22411. The first spring strip 2244 comprises a first electric connection part 22441, an elastic part 22442 and a first fixing part 22443. The first fixing part 22443 is fixed on the pedestal 22411. Moreover, the first fixing part 22443 is arranged between the first electric connection part 22441 and the elastic part 22442. The elastic part 22442 is disposed within the casing 2241 and contacted with the protrusion structure 22431 of the linkage element 2243. Moreover, the elastic part 22442 can be swung relative to the first fixing part 22443. After the first electric connection part 22441 is penetrated downwardly through the pedestal 22411, the first electric connection part 22441 is contacted and electrically connected with the circuit board 21. The second spring strip 2245 is arranged between the linkage element 2243 and the first spring strip 2244. The second spring strip 2245 comprises a second electric connection part 22451, a conduction part 22452 and a second fixing part 22453. The second fixing part 22453 is fixed on the pedestal 22411. Moreover, the second fixing part 22453 is arranged between the second electric connection part 22451 and the conduction part 22452. The conduction part 22452 is disposed within the casing 2241. After the second electric connection part 22451 is penetrated downwardly through the pedestal 22411, the second electric connection part 22451 is contacted and electrically connected with the circuit board 21.

While the keycap 221 is depressed, the keycap 221 is moved downwardly to push the push element 2242. Since the linkage element 2243 is connected with the push element 2242, the linkage element 2243 is moved downwardly with the push element 2242. At the same time, the elastic element 2246 is compressed to generate the elastic force. As the linkage element 2243 is moved downwardly, the protrusion structure 22431 of the linkage element 2243 is contacted with the elastic part 22442 of the first spring strip 2244. Moreover, the protrusion structure 22431 is moved downwardly relative to the elastic part 22442 so as to push the elastic part 22442. Consequently, the elastic part 22442 is swung relative to the first fixing part 22443. As the linkage element 2243 is continuously moved downwardly, the swung elastic part 22442 correspondingly contacts and collides with the conduction part 22452 of the second spring strip 2245. Meanwhile, as shown in FIG. 4, the first spring strip 2244 and the second spring strip 2245 are in contact with each other. Consequently, the circuit board 21 generates a corresponding key signal.

When the elastic part 22442 of the first spring strip 2244 collides with the conduction part 22452 of the second spring strip 2245, a click sound is generated. Due to the click sound, the user can feel the feedback of depressing the keycap 221. Moreover, when the keycap 221 is no longer depressed, the linkage element 2243 and the push element 2242 are moved upwardly in response to the elastic force of the elastic element 2246. Consequently, the keycap 221 is returned to its original position as shown in FIG. 3. The operations of the mechanical switch 224 are well known to those skilled in the art, and are not redundantly described herein. The type of the mechanical switch 224 is not restricted to that of FIGS. 3 and 4.

The circuit board 21 further comprises diodes 24. The diodes 24 are electrically connected with the mechanical switches 224 for blocking the current in the reverse direction. Due to the diodes 24, a key conflict problem of plural mechanical key structures is avoided. That is, the serially-connected diodes between the circuit board 21 and the mechanical switches 224 can block the interaction between plural mechanical key structures 22. Consequently, even if the keycaps 221 of plural mechanical key structures 22 are simultaneously depressed, the keyboard device 2 can recognize the keycaps 221 of the depressed mechanical key structures 22. In other words, the keyboard device 2 has the anti-ghosting function.

However, the keyboard device 2 still has some drawbacks. Firstly, the contact area between the keycap 221 and the push element 2242 is too small. Consequently, the keycap 221 cannot be uniformly supported by the push element 2242. Since the keycap 221 is rocked and unstable in the forward/backward direction or the leftward/rightward direction, the tactile feel of operating the keycap 221 is deteriorated. Especially when the edge of the keycap 221 is depressed, the rocking extent of the keycap 221 becomes serious. Secondly, the locations of the diodes 24 serially connected with the mechanical switches 224 are determined according to the structures of the mechanical switches 224. Generally, the locations of the diodes 24 and the light-emitting elements 23 are limited. For example, if the locations of the light-emitting elements 23 are not aligned with the symbols (not shown) of the keycaps 221, the illuminating effect is deteriorated.

Therefore, there is a need of providing a keyboard device while retaining the advantages of the above two conventional keyboard devices and solving the drawbacks of the above two conventional keyboard devices.

### SUMMARY OF THE INVENTION

The present invention relates to a keyboard device with an anti-ghosting unit. While each keycap of the keyboard device is moved upwardly or downwardly, the keycap is not loosened or rocked. Moreover, the illuminating function of each key structure can be selectively enabled or disabled. The locations of the light-emitting element and the anti-ghosting unit are not restricted. Consequently, the illuminating effect of the keycap is enhanced.

In accordance with an aspect of the present invention, there is provided a keyboard device. The keyboard device includes a wiring board with plural key switches, plural key structures corresponding to the plural key switches, and an anti-ghosting unit. Each of the plural key structures includes a keycap, a scissors-type connecting element and a light-emitting element. The light-emitting element is located under the keycap. At least a part of the scissors-type connecting element is arranged between the keycap and the wiring board. The keycap is movable upwardly or downwardly relative to the wiring board. The anti-ghosting unit is disposed on the wiring board or electrically connected with the wiring board. The anti-ghosting unit is used for avoiding key conflict between at least two of the plural key structures.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a schematic side view illustrating a conventional keyboard device;

FIG. 2 is a schematic exploded view illustrating a portion of a membrane wiring board of the conventional keyboard device of FIG. 1;

FIG. 3 is a schematic cross-sectional view illustrating a conventional keyboard device with a mechanical key structure;

FIG. 4 is a schematic cross-sectional view illustrating the mechanical switch of the conventional keyboard device of FIG. 3 when a keycap of the mechanical key structure is depressed;

FIG. 5 is a schematic side view illustrating a keyboard device according to a first embodiment of the present invention;

FIG. 6 is a schematic exploded view illustrating a portion of a membrane wiring board of the keyboard device of FIG. 5;

FIG. 7 is a schematic side view illustrating a keyboard device according to a second embodiment of the present invention;

FIG. 8 is a schematic side view illustrating a keyboard device according to a third embodiment of the present invention; and

FIG. 9 is a schematic side view illustrating a keyboard device according to a fourth embodiment of the present invention.

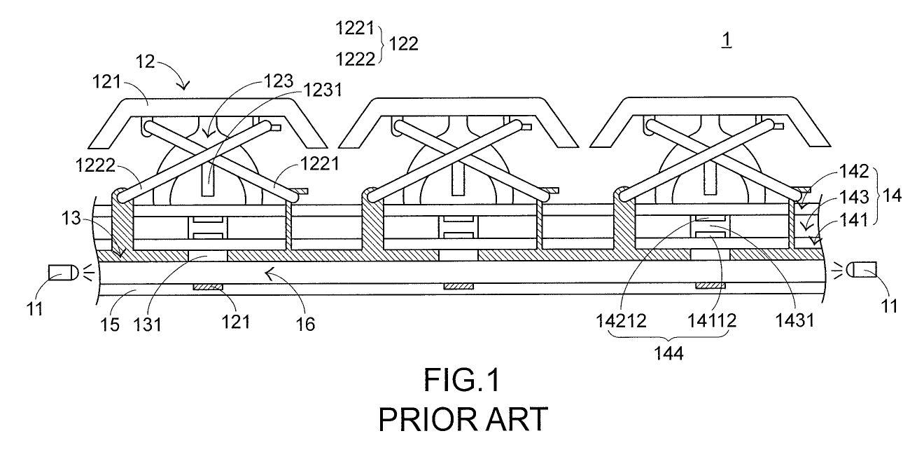

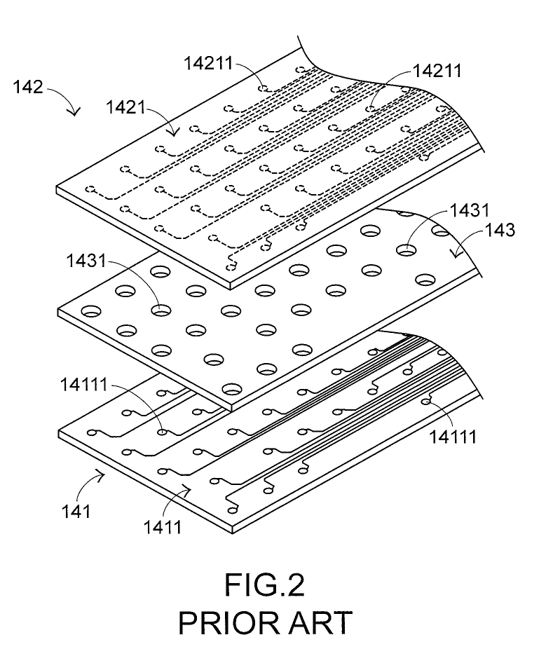

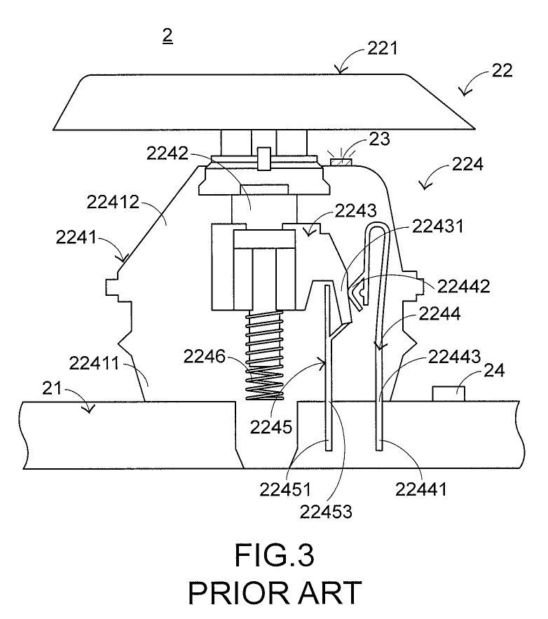

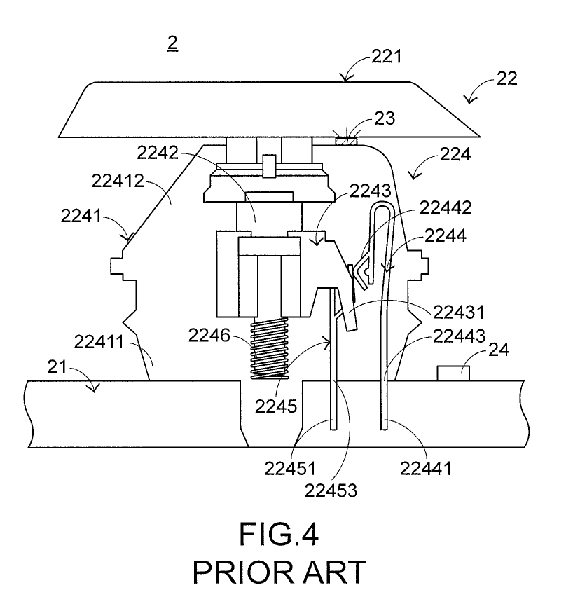

### DETAILED DESCRIPTION OF THE PREFERRED EMBODIMENT

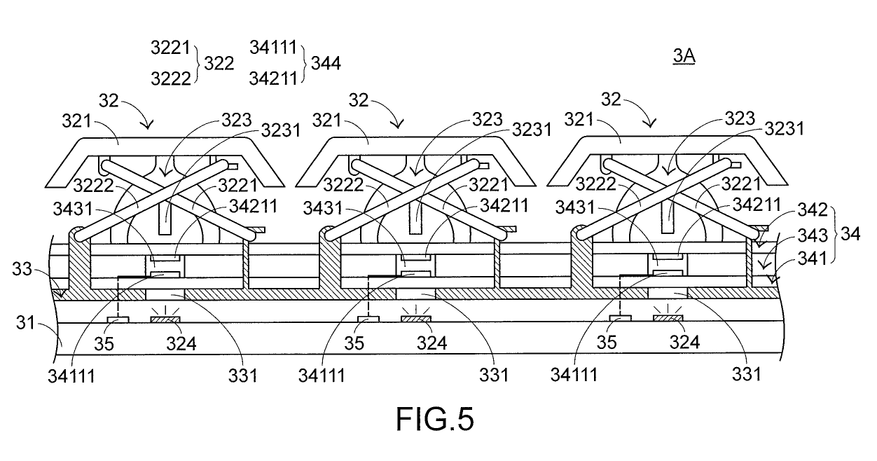

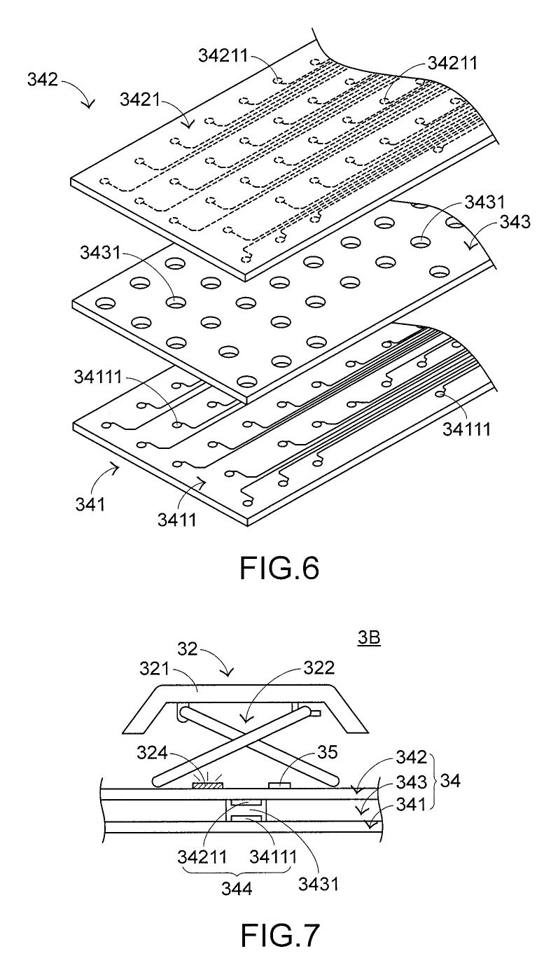

Please refer to FIGS. 5 and 6. FIG. 5 is a schematic side view illustrating a keyboard device according to a first embodiment of the present invention. FIG. 6 is a schematic exploded view illustrating a portion of a membrane wiring board of the keyboard device of FIG. 5. The keyboard device 3A comprises plural key structures 32, a wiring board 34, a base plate 33 and a circuit board 31. Each of the plural key structures 32 comprises a keycap 321, a scissors-type connecting element 322, an elastic element 323 and a light-emitting element 324. The scissors-type connecting element 322 is connected between the keycap 321 and the base plate 33. Moreover, the scissors-type connecting element 322 comprises a first frame 3221 and a second frame 3222. The second frame 3222 is pivotally coupled to the first frame 3221. Consequently, the first frame 3221 and the second frame 3222 can be swung relative to each other. The elastic element 323 is arranged between the keycap 321 and the membrane wiring board 34. Moreover, the elastic element 323 comprises a contacting part 3231.

In this embodiment, the wiring board 34 is a membrane wiring board 34. The wiring board 34 is arranged between the base plate 33 and the keycaps 321. The wiring board 34 comprises an upper film layer 342, a lower film layer 341 and an intermediate film layer 343. The intermediate film layer 343 is arranged between the upper film layer 342 and the lower film layer 341. A first circuit pattern 3421 is formed on a bottom surface of the upper film layer 342. The first circuit pattern 3421 comprises plural upper contacts 34211 corresponding to the plural key structures 32. A second circuit pattern 3411 is formed on a top surface of the lower film layer 341. The second circuit pattern 3431 comprises plural lower contacts 34111 corresponding to the plural upper contacts 34211. In addition, the intermediate film layer 343 comprises plural perforations 3431 corresponding to the plural upper contacts 34211 and the plural lower contacts 34111. Each of the upper contacts 34211 and the corresponding lower contact 34111 are collectively defined as a membrane switch 344.

While the keycap 321 of any key structure 32 is depressed and moved downwardly relative to the base plate 33, the first frame 3221 and the second frame 3222 of the scissors-type connecting element 322 are switched from an open-scissors state to a stacked state. Moreover, as the keycap 321 is moved downwardly to compress the elastic element 323, the corresponding upper contact 34211 is contacted with and triggered by the contacting part 3231 of the elastic element 323. Consequently, the corresponding upper contact 34211 is penetrated through the corresponding perforation 3431 and contacted with the corresponding lower contact 34111. Under this circumstance, the corresponding membrane switch 344 is electrically conducted. When the keycap 321 of the key structure 32 is no longer depressed, the keycap 321 is moved upwardly relative to the base plate 33 in response to an elastic force of the elastic element 323. Meanwhile, the first frame 3221 and the second frame 3222 are switched from the stacked state to the open-scissors state again, and the keycap 321 is returned to its original position. Due to the scissors-type connecting element 322, the keycap 321 is not loosened or rocked while the keycap 321 is moved upwardly or downwardly. Consequently, the tactile feel of operating the keycap 321 is enhanced.

The base plate 33 is located over the circuit board 31. Moreover, the base plate 33 comprises plural base plate openings 331 corresponding to the plural key structures 32. The plural light-emitting elements 324 are disposed on the circuit board 31 and aligned with the corresponding key structures 32. The light-emitting elements 324 acquire electric power from the circuit board 31, and thus the light-emitting elements 324 provide the light beams. The light beams from each light-emitting element 324 are projected onto the corresponding keycap 321 through the corresponding base plate opening 331 and the wiring board 34 sequentially. Consequently, the keycap 321 is illuminated. The locations of the light-emitting elements 324 may be varied according to the practical requirements. For example, the light-emitting elements 324 are aligned with the symbols (not shown) of the corresponding keycaps 321. Consequently, the illuminating effect of the keycaps 321 will be enhanced. In accordance with a feature of the present invention, each light-emitting element 324 can be selectively turned on or turned off. That is, according to the user's requirement, the illuminating functions corresponding to the keycaps 321 of specified key structures 32 are enabled, and the illuminating functions corresponding to the keycaps 321 of the other key structures 32 are disabled.

Moreover, the keyboard device 3A further comprises an anti-ghosting unit corresponding to the plural key structures 32. In an embodiment, the anti-ghosting unit comprises plural diodes 35. The diodes 35 are electrically connected with the corresponding key switches 344 for blocking the current in the reverse direction. Due to the diodes 35, the key conflict problem of plural key structures 32 is avoided. That is, the diodes 35 are disposed on the circuit board 31 and electrically connected with the corresponding key switches 344 to block the interaction between the corresponding key switches 344. Consequently, even if the keycaps 321 of plural key structures 32 are simultaneously depressed, the keyboard device 3A can recognize the keycaps 321 of the depressed key structures 32. In other words, the keyboard device 3 has the anti-ghosting function. The principles of using the diodes 35 to achieve the anti-ghosting function are well known to those skilled in the art, and are not redundantly described herein. In the above embodiment, all key structures 32 are electrically connected with the corresponding diodes 35. It is noted that numerous modifications and alterations may be made while retaining the teachings of the invention. For example, in another embodiment, some key structures 32 are electrically connected with the corresponding diodes 35.

FIG. 7 is a schematic side view illustrating a keyboard device according to a second embodiment of the present invention. For succinctness, only one key structure and associated components are shown in FIG. 7. The keyboard device of this embodiment also comprises plural elastic elements and a base plate, but the elastic elements and the base plate are not shown. The components of the keyboard device 3B of this embodiment similar to those of the first embodiment are not redundantly described herein. In the first embodiment, the circuit board 31 is located under the wiring board 34 of the keyboard device 3A. In comparison with the first embodiment, the keyboard device 3B of this embodiment is not equipped with the circuit board 31. Correspondingly, the plural diodes 35 and the plural light-emitting elements 324 corresponding to the plural key structures 32 are disposed on the top surface of the wiring board, disposed within the wiring board 34 or disposed on the bottom surface of the wiring board 34.

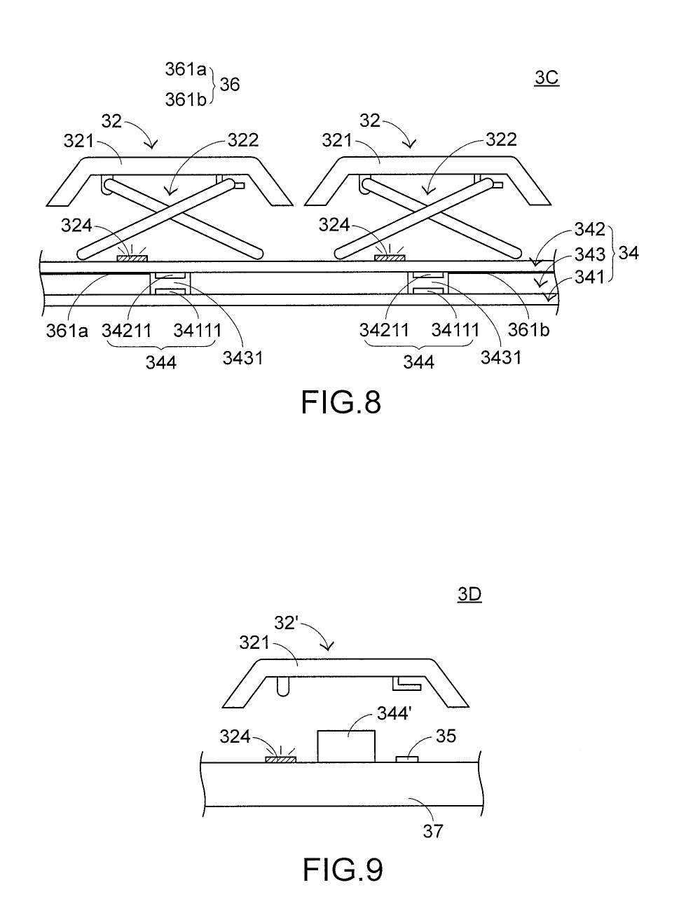

FIG. 8 is a schematic side view illustrating a keyboard device according to a third embodiment of the present invention. For succinctness, only two key structures and associated components are shown in FIG. 8. The keyboard device of this embodiment also comprises plural elastic elements and a base plate, but the elastic elements and the base plate are not shown. The components of the keyboard device 3C of this embodiment similar to those of the second embodiment are not redundantly described herein. In comparison with the second embodiment, the anti-ghosting unit comprises an anti-ghosting circuit pattern 36. The anti-ghosting circuit pattern 36 comprises plural conductive lines 361a and 361b corresponding to the plural key structures 32. The conductive lines 361a and 361b are electrically connected with the corresponding key switches 344. Every two adjacent conductive lines 361a and 361b are separated from each other. Consequently, even if the keycaps 321 of plural key structures 32 are simultaneously depressed, the keyboard device 3C can recognize the keycaps 321 of the depressed key structures 32.

FIG. 9 is a schematic side view illustrating a keyboard device according to a fourth embodiment of the present invention. For succinctness, only one key structure and associated components are shown in FIG. 9. The keyboard device of this embodiment also comprises plural scissors-type connecting elements and a base plate, but the scissors-type connecting elements and the base plate are not shown. The components of the keyboard device 3D of this embodiment similar to those of the second embodiment are not redundantly described herein. In comparison with the second embodiment, the wiring board is replaced by a circuit board 37. The key switches 344′ are disposed on the circuit board 37. The types of the key switches 344′ are not restricted to the above-mentioned key switches (i.e., the membrane switches). While the key switch 344′ is depressed by the corresponding keycap 321, the key switch 344′ is electrically conducted. Similarly, the plural diodes 35 and the plural light-emitting elements 324 corresponding to the plural key structures 32′ are disposed on the circuit board 37.

From the above descriptions, the keyboard device of the present invention has many advantages. Firstly, the keycap is not loosened or rocked while each keycap is moved upwardly or downwardly. Secondly, the illuminating function of each key structure is selectively enabled or disabled. Thirdly, all key structures have no conflict problems. Fourthly, the locations of the light-emitting elements and the anti-ghosting unit may be varied according to the practical requirements, so that the illuminating efficacy of the keycap is enhanced.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all modifications and similar structures.

What is claimed is:

1. A keyboard device, comprising:
a wiring board comprising plural key switches;
plural key structures corresponding to the plural key switches, wherein each of the plural key structures comprises a keycap, a scissors-type connecting element and a light-emitting element, wherein the light-emitting element is located under the keycap, at least a part of the scissors-type connecting element is arranged between the keycap and the wiring board, and the keycap is movable upwardly or downwardly relative to the wiring board; and
an anti-ghosting unit disposed on the wiring board or electrically connected with the wiring board, wherein the anti-ghosting unit avoids key conflict between at least two of the plural key structures.

2. The keyboard device according to claim 1, further comprising a base plate under the wiring board, wherein the scissors-type connecting element is connected between the base plate and the keycap.

3. The keyboard device according to claim 1, further comprising a circuit board under the base plate, wherein the anti-ghosting unit comprises at least one diode, and the at least one diode is disposed on the circuit board.

4. The keyboard device according to claim 3, wherein the at least one diode comprises plural diodes corresponding to the plural key structures.

5. The keyboard device according to claim 3, wherein the light-emitting element is disposed on the circuit board.

6. The keyboard device according to claim 1, wherein the anti-ghosting unit comprises at least one diode, and the at least one diode is disposed on the wiring board.

7. The keyboard device according to claim 6, wherein the at least one diode comprises plural diodes corresponding to the plural key structures.

8. The keyboard device according to claim 1, wherein the anti-ghosting unit comprises an anti-ghosting circuit pattern, and the anti-ghosting circuit pattern comprises at least two conductive lines, wherein the at least two conductive lines are separated from each other and electrically connected with at least two of the plural key switches, respectively.

9. The keyboard device according to claim 1, wherein the light-emitting element is disposed on the wiring board.

10. The keyboard device according to claim 1, wherein the wiring board is a membrane wiring board with an upper film layer and a lower film layer, wherein a first circuit pattern is formed on the upper film layer, a second circuit pattern is formed on the lower film layer, the first circuit pattern comprises plural upper contacts, and the second circuit pattern comprises plural lower contacts, wherein each of the upper contacts and the corresponding lower contact are separated from each by a spacing distance and collectively defined as the corresponding membrane switch.

11. The keyboard device according to claim 10, wherein each of the plural key structures further comprises an elastic element with a contacting part, and the elastic element is arranged between the keycap and the wiring board, wherein while the keycap is depressed, the elastic element is compressed and the key switch is pushed by the contacting part, wherein when the keycap is not depressed, the keycap is returned to an original position in response to an elastic force of the elastic element.
